(19) United States
(12) Patent Application Publication
(10) Pub. No.: US 2026/0252454 A1
(43) Pub. Date: Aug. 27, 2026

(54) MANAGING DATA COLLECTION OF COMPUTING COMPONENTS OF AN INFORMATION HANDLING SYSTEM

(71) Applicant: Dell Products L.P., Round Rock, TX (US)

(72) Inventors: Ibrahim Sayyed, Georgetown, TX (US); Srivatsa Venkataramiah Seshachalam, Bengaluru (IN); Cheng Chien Hsu, Taipei City (TW); Alan Helmy Abdelhalim, Pflugerville, TX (US)

(21) Appl. No.: 19/060,374

(22) Filed: Feb. 21, 2025

(51) Int. Cl. G06F 11/30

(52) U.S. Cl. CPC G06F 11/3058; G06F 11/3055

(57) ABSTRACT

Managing telemetry data collection of computing components, including determining that operating conditions of the computing components indicate a telemetry collection mode of the computing components, and in response, performing telemetry data collection of the computing components, including identifying runtime characteristics of the computing components system; for each of the runtime characteristics: comparing the particular runtime characteristic to a telemetry data collection operating range associated with the particular runtime characteristic; determining, based on the comparing, whether the particular runtime characteristic is outside of the telemetry data collection operating range associated with the particular runtime characteristic; determining an aggregation value of the runtime characteristics that are outside of respective telemetry data collection operating ranges; adjusting a frequency of the telemetry data collection of the computing components for a period of time based on the aggregation value of the runtime characteristics that are outside of respective telemetry data collection operating ranges.

### BACKGROUND

### Field of the Disclosure

The disclosure relates generally to an information handling system, and in particular, managing telemetry data collection of computing components of an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Telemetry data collection involves gathering real-time data from remote or inaccessible sources for monitoring and analysis. This data is used for understanding system performance, detecting anomalies, and making informed decisions. Various industries, including telecommunications, healthcare, and automotive, rely on telemetry to ensure their systems and devices operate efficiently and effectively.

### SUMMARY

Innovative aspects of the subject matter described in this specification may be embodied in a method of managing telemetry data collection of computing components of an information handling system, the method including identifying operating conditions of the computing components of the information handling system; determining that the operating conditions of the computing components indicate a telemetry collection mode of the computing components, and in response, performing telemetry data collection of the computing components, including: identifying runtime characteristics of the computing components of the information handling system; for each of the runtime characteristics: comparing the particular runtime characteristic to a telemetry data collection operating range associated with the particular runtime characteristic; determining, based on the comparing, whether the particular runtime characteristic is outside of the telemetry data collection operating range associated with the particular runtime characteristic; determining an aggregation value of the runtime characteristics that are outside of respective telemetry data collection operating ranges; and adjusting a frequency of the telemetry data collection of the computing components for a period of time based on the aggregation value of the runtime characteristics that are outside of respective telemetry data collection operating ranges.

Other embodiments of these aspects include corresponding systems, apparatus, and computer programs, configured to perform the actions of the methods, encoded on computer storage devices.

These and other embodiments may each optionally include one or more of the following features. For instance, the computing components include one or more of a central processing unit (CPU), memory, disk drive, a graphics processing unit (GPU), fan, thermistors, and battery. Wherein identifying operating conditions of the computing components further includes identifying a power input state of the information handling system, and wherein determining that the operating conditions of the computing components indicate the telemetry collection mode further includes determining that the power input state of the information handling system indicates AC power input state, and in response, performing the telemetry data collection of the computing components. Wherein identifying operating conditions of the computing components further includes identifying a revolutions per minute (RPM) of a fan over a time period of the information handling system, and wherein determining that the operating conditions of the computing components indicate the telemetry collection mode further includes determining that the RPM of the fan over the time period of the information handling system is maintained above a threshold, and in response, performing the telemetry data collection of the computing components. Wherein identifying the runtime characteristics of the computing components further includes identifying an input power state of the information handling system, wherein comparing the particular runtime characteristics to the telemetry data collection operating range associated with the particular runtime characteristic further includes comparing the input power state of the information handling system to the telemetry data collection operating range associated with an AC input power state of the information handling system, and wherein determining whether the particular runtime characteristic is outside of the telemetry data collection operating range further includes determining that the input power state is a DC input power state and outside of the telemetry data collection operating range associated with an AC input power state of the information handling system. Wherein identifying the runtime characteristics of the computing components further includes a status of software at the information handling system, wherein comparing the particular runtime characteristics to the telemetry data collection operating range associated with the particular runtime characteristic further includes comparing update status of the software of the information handling system to the telemetry data collection operating range associated with updating of the software at the information handling system, and wherein determining whether the particular runtime characteristic is outside of the telemetry data collection operating range further includes determining that the update status of the software indicates a current update of the software is occurring and outside of the telemetry data collection operating range associated with no current updating of the software is occurring. Wherein identifying the runtime characteristics of the computing components further includes identifying a disk read/write cycle of the information handling system, wherein comparing the particular runtime characteristics to the telemetry data collection operating range associated with the particular runtime characteristic further includes comparing the disk read/write cycle of the information handling system to the telemetry data collection operating range associated with a disk read/write cycle range of the information handling system, and wherein determining whether the particular runtime characteristic is outside of the telemetry data collection operating range further includes determining that the disk read/write cycle is outside of the disk read/write cycle range. Wherein identifying the runtime characteristics of the computing components further includes identifying a system management interrupt (SMI) duration of the information handling system, wherein comparing the particular runtime characteristics to the telemetry data collection operating range associated with the particular runtime characteristic further includes comparing the SMI duration of the information handling system to the telemetry data collection operating range associated with a SMI duration range of the information handling system, and wherein determining whether the particular runtime characteristic is outside of the telemetry data collection operating range further includes determining that the SMI duration is outside of the SMI duration range. Identifying historical characteristics of the information handling system; for each of the historical characteristics: comparing the particular historical characteristic to a telemetry data collection operating range associated with the particular historical characteristic; determining, based on the comparing, whether the particular historical characteristic is outside of the telemetry data collection operating range associated with the historical runtime characteristic; determining the aggregation value of i) the runtime characteristics that are outside of respective telemetry data collection operating ranges and ii) the historical characteristics that are outside of respective telemetry data collection operating ranges; and adjusting the frequency of the telemetry data collection of the computing components for the period of time based on the aggregation value of i) the runtime characteristics that are outside of respective telemetry data collection operating ranges and ii) the historical characteristics that are outside of respective telemetry data collection operating ranges. Wherein identifying the historical characteristics of the computing components further includes identifying a number of system failures of the information handling system, wherein comparing the particular runtime characteristics to the telemetry data collection operating range associated with the particular runtime characteristic further includes comparing the number of system failures of the information handling system to the telemetry data collection operating range associated with a system failure range of the information handling system, and wherein determining whether the particular runtime characteristic is outside of the telemetry data collection operating range further includes determining that the number of system failures is outside of the system failure range. Adjusting the frequency of telemetry data collection of the computing components for the time period includes throttling the frequency of the telemetry data collection of the computing components for the time period. Adjusting the frequency of telemetry data collection of the computing components for the time period includes suspending the frequency of the telemetry data collection of the computing components for the time period. Wherein determining an aggregation value of the runtime characteristics that are outside of respective telemetry data collection operating ranges further includes: determining, for each runtime characteristic that is outside of respective telemetry data collection operating ranges, a weighted value of the runtime characteristic; and determining a summation of the weighted values of each of the runtime characteristics, wherein adjusting the frequency of the telemetry data collection of the computing components further includes: comparing the summation of the weighted values of each of the runtime characteristics to a threshold; determining, based on the comparing, that the summation of the weighted values of each of the runtime characteristics is greater than the threshold; and in response to determining that the summation of the weighted values of each of the runtime characteristics is greater than the threshold, adjusting the frequency of the telemetry data collection of the computing components for the time period. Adjusting, based on the adjusted frequency of the telemetry data collection, a computational parameter of a particular computing component.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing telemetry data collection of computing components of the information handling system.

FIG. 3 illustrates a method for managing telemetry data collection of computing components of the information handling system.

### DESCRIPTION OF PARTICULAR EMBODIMENT(S)

This disclosure discusses methods and systems for managing telemetry data collection of computing components of an information handling system. In short, a telemetry and instrumentation data collection process must be designed to be aware of the computing components and resources thereof. Ignoring the need for efficient telemetry collection that takes into account computing components'resources can lead to several risks, such as performance degradation, resource starvation, overhead impact, fault detection delay, and energy inefficiency. The current invention provides an energy efficient method and context aware telemetry collection based on performance runtime indicators, including automatic detection of system overload and performing actions in response to such to minimize exacerbating any problems by throttling or rescheduling telemetry operations (as opposed to cancelling such), described further herein.

Specifically, this disclosure discusses a system and a method for managing telemetry data collection of computing components of an information handling system, including identifying operating conditions of the computing components of the information handling system; determining that the operating conditions of the computing components indicate a telemetry collection mode of the computing components, and in response, performing telemetry data collection of the computing components, including: identifying runtime characteristics of the computing components of the information handling system; for each of the runtime characteristics: comparing the particular runtime characteristic to a telemetry data collection operating range associated with the particular runtime characteristic; determining, based on the comparing, whether the particular runtime characteristic is outside of the telemetry data collection operating range associated with the particular runtime characteristic; determining an aggregation value of the runtime characteristics that are outside of respective telemetry data collection operating ranges; and adjusting a frequency of the telemetry data collection of the computing components for a period of time based on the aggregation value of the runtime characteristics that are outside of respective telemetry data collection operating ranges.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

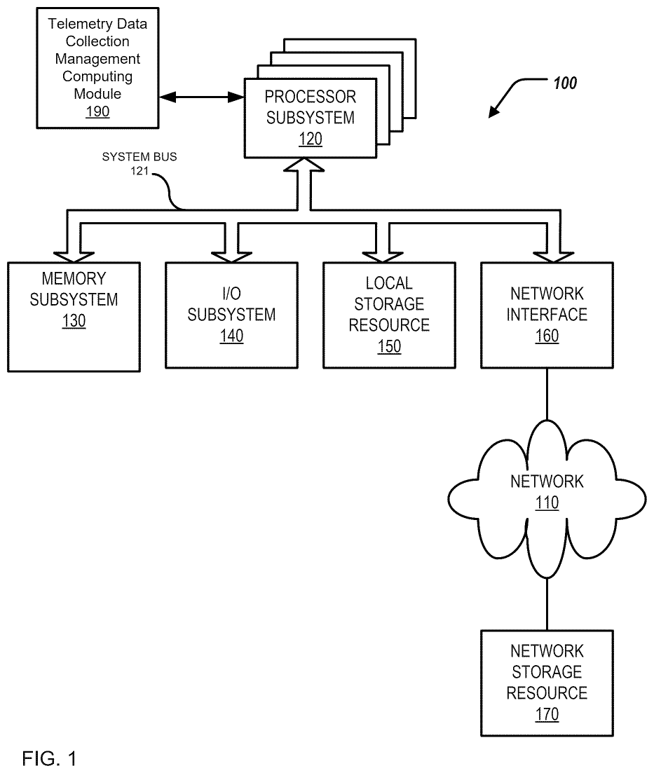

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a telemetry data collection management computing module 190. The telemetry data collection management computing module 190 can be in communication with the processor subsystem 120, or included by the processor subsystem 120. In some examples, the telemetry data collection management computing module 190 is included by an embedded controller (EC) of the information handling system 100. In some examples, the telemetry data collection management computing module 190 is included by a baseband management controller of the information handling system 100.

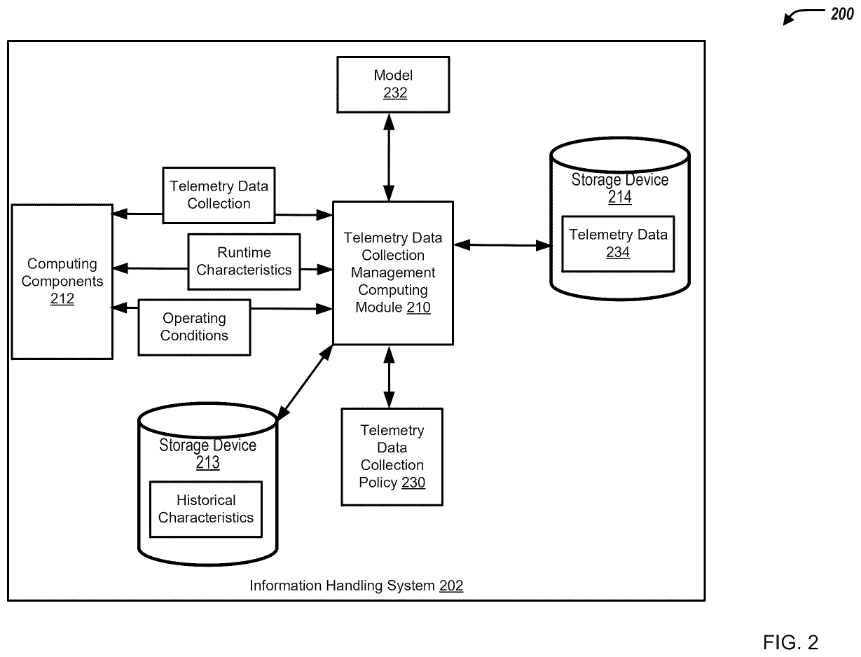

Turning to FIG. 2, FIG. 2 illustrates an environment 200 including an information handling system 202. The information handling system 202 can include a telemetry data collection management computing module 210, computing components 212, a storage device 213, and a storage device 214. In some examples, the information handling system 202 is similar to, or includes, the information handling system 100 of FIG. 1. In some examples, the telemetry data collection management computing module 210 is the same, or substantially the same, as the telemetry data collection management computing module 190 of FIG. 1.

The telemetry data collection management computing module 210 can be in communication with the computing components 212, the storage device 213, and the storage device 214.

The computing components 212 can include one or more of a central processing unit (CPU), memory (such as DDR), disk drive (such as HDD or SDD), graphics processing unit (GPU), fan, thermistors, battery, or any type of processing/computing element.

In short, a telemetry and instrumentation data collection process must be designed to be aware of the computing components 212 and resources thereof. Ignoring the need for efficient telemetry collection that takes into account computing components 212 resources can lead to several risks, such as performance degradation, resource starvation, overhead impact, fault detection delay, and energy inefficiency. The current invention provides an energy efficient method and context aware telemetry collection based on performance runtime indicators; including automatic detection of system overload and performing actions in response to such to minimize exacerbating any problems by throttling or rescheduling telemetry operations (as opposed to cancelling such), described further herein.

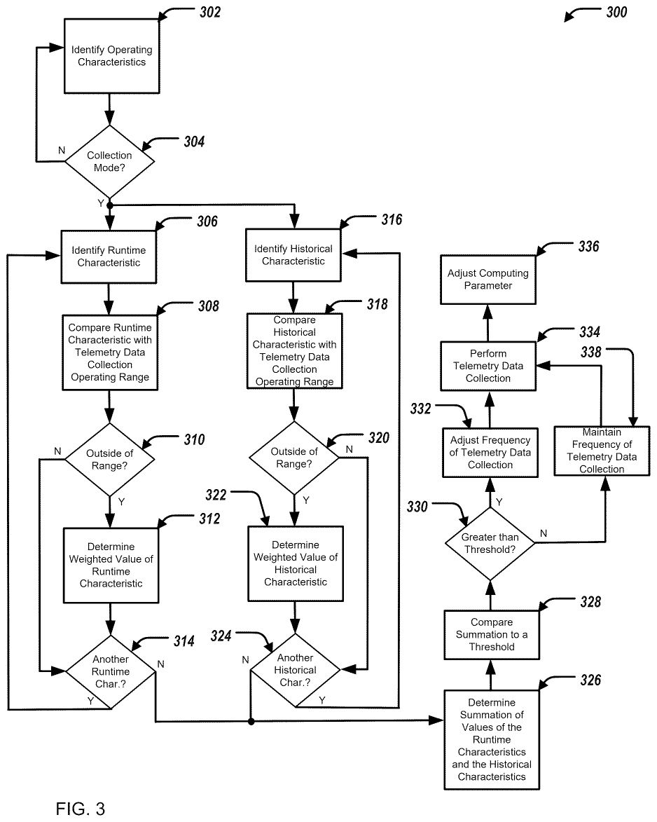

FIG. 3 illustrates a flowchart depicting selected elements of an embodiment of a method 300 for managing telemetry data collection of computing components of the information handling system. The method 300 may be performed by the information handling system 100, the information handling system 202 and/or the telemetry data collection management computing module 210, and with reference to FIGS. 1-2. It is noted that certain operations described in method 300 may be optional or may be rearranged in different embodiments.

The telemetry data collection management computing module 210 can identify operating conditions of the computing components 212, at 302. The telemetry data collection management computing module 210 can determine that the operating conditions of the computing components 212 indicate a telemetry collection mode of the computing components 212, at 304. In other words, the telemetry data collection management computing module 210 checks whether the computing components 212 are in a condition for further telemetry data collection thereof.

For example, the telemetry data collection management computing module 210 can determine whether the information handling system 202 is on AC or DC power. In some examples, the telemetry data collection management computing module 210 can identify the operating conditions of the computing components 212 by identifying a power input state of the information handling system 202. The telemetry data collection management computing module 210 can determine that the operating conditions of the computing components 212 can indicate the telemetry collection mode by determining that the power input state of the information handling system 202 indicates an AC power input state.

For example, the telemetry data collection management computing module 210 can determine whether the health of a fan computing component is satisfactory or not based on maintenance of RPM levels of the fan. In some examples, the telemetry data collection management computing module 210 can identify the operating conditions of the computing components 212 by identifying a revolutions per minute (RPM) of the fan over a time period. The telemetry data collection management computing module 210 can determine that the operating conditions of the computing components 212 can indicate the telemetry collection mode by determining that the RPM of the fan over the time period is maintained above a threshold.

For example, the telemetry data collection management computing module 210 can determine whether power limits (PL1/PL2) of the CPU are within a threshold range. In some examples, the telemetry data collection management computing module 210 can identify the operating conditions of the computing components 212 by identifying power limits of the CPU over a time period. The telemetry data collection management computing module 210 can determine that the operating conditions of the computing components 212 can indicate the telemetry collection mode by determining that the power limits of the CPU over the time period is maintained within a threshold range.

For example, the telemetry data collection management computing module 210 can determine whether the core temperature of the CPU is within a threshold range. In some examples, the telemetry data collection management computing module 210 can identify the operating conditions of the computing components 212 by identifying the core temperature of the CPU over a time period. The telemetry data collection management computing module 210 can determine that the operating conditions of the computing components 212 can indicate the telemetry collection mode by determining that the core temperature of the CPU over the time period is maintained within a threshold range.

For example, the telemetry data collection management computing module 210 can determine whether Self-Monitoring, Analysis, and Reporting Technology (SMART) data of the disk drive indicate a health status above a threshold. In some examples, the telemetry data collection management computing module 210 can identify the operating conditions of the computing components 212 by identifying the SMART data of the disk drive over a time period. The telemetry data collection management computing module 210 can determine that the operating conditions of the computing components 212 can indicate the telemetry collection mode by determining that the SMART data of the disk drive over the time period indicates a health status above a threshold.

For example, the telemetry data collection management computing module 210 can determine whether GPU frequency levels are within a threshold range. In some examples, the telemetry data collection management computing module 210 can identify the operating conditions of the computing components 212 by identifying GPU frequency levels over a time period. The telemetry data collection management computing module 210 can determine that the operating conditions of the computing components 212 can indicate the telemetry collection mode by determining that the GPU frequency levels over the time period is with a threshold range.

For example, the telemetry data collection management computing module 210 can determine whether GPU load is within a threshold range. In some examples, the telemetry data collection management computing module 210 can identify the operating conditions of the computing components 212 by identifying GPU load over a time period. The telemetry data collection management computing module 210 can determine that the operating conditions of the computing components 212 can indicate the telemetry collection mode by determining that the GPU load over the time period is with a threshold range.

The telemetry data collection management computing module 210, after determining that the operating conditions of the computing components 212 indicate the telemetry collection mode of the computing components 212 (at 304), in response, performs telemetry data collection of the computing components 212. Specifically, the telemetry data collection management computing module 210 identifies a particular runtime characteristic of the computing components 212, at 306. The telemetry data collection management computing module 210 compares the particular runtime characteristic with a telemetry data collection operating range associated with the particular runtime characteristic, at 308. For example, the telemetry data collection management computing module 210 can access a telemetry data collection policy 230. The telemetry data collection policy 230 can associate, for each runtime characteristic, the telemetry data collection operating range for the runtime characteristic. The telemetry data collection management computing module 210 determines, based on the comparing, whether the particular runtime characteristic is outside of the telemetry data collection range associated with the particular runtime characteristic, at 310. In some examples, if the telemetry data collection management computing module 210 determines that the particular runtime characteristic is outside of the telemetry data collection range associated with the particular runtime characteristic, the telemetry data collection management computing module 210 determines a weighted value of the particular runtime characteristic, at 312.

For example, the telemetry data collection management computing module 210 can determine if the system input power is changed to DC input power. In some examples, the telemetry data collection management computing module 210 can identify the runtime characteristics of the computing components 212 by identifying an input power state of the information handling system 202. The telemetry data collection management computing module 210 can compare the particular runtime characteristic to the telemetry data collection operating range associated with the particular runtime characteristic by comparing the input power state of the information handling system 202 to the telemetry data collection operating range associated with an AC input power state of the information handling system 202. The telemetry data collection management computing module 210 determines whether the particular runtime characteristic is outside of the telemetry data collection operating range by determining that the input power state is a DC input power state and outside of the telemetry data collection operating range associated with an AC input power state of the information handling system 202. The telemetry data collection management computing module 210 can determine a weighted value for the runtime characteristics of the input power state of the information handling system 202.

For example, the telemetry data collection management computing module 210 can determine if the software and/or the operating system (OS) is being updated/installed at the information handling system 202. In some examples, the telemetry data collection management computing module 210 can identify the runtime characteristics of the computing components 212 by identifying a status of software (computer-executable instructions software) at the information handling system 202. The telemetry data collection management computing module 210 can compare the particular runtime characteristic to the telemetry data collection operating range associated with the particular runtime characteristics by comparing the update status of the software to the telemetry data collection operating range associated with updating of the software at the information handling system 202. The telemetry data collection management computing module 210 determines whether the particular runtime characteristic is outside of the telemetry data collection operating range by determining that the update status of the software indicates a currently occurring update of the software and outside of the telemetry data collection operating range associated with no current updating of the software is occurring. The telemetry data collection management computing module 210 can determine a weighted value for the runtime characteristics of the status of software at the information handling system 202.

For example, the telemetry data collection management computing module 210 can determine if the disk read/write cycles are outside of a threshold range. In some examples, the telemetry data collection management computing module 210 can identify the runtime characteristics of the computing components 212 by identifying a disk read/write cycle count within a time period. The telemetry data collection management computing module 210 can compare the particular runtime characteristic to the telemetry data collection operating range associated with the particular runtime characteristics by comparing the disk read/write cycle count of the information handling system 202 to the telemetry data collection operating range associated with a disk read/write cycle range of the information handling system 202. The telemetry data collection management computing module 210 determines whether the particular runtime characteristic is outside of the telemetry data collection operating range by determining that the disk read/write cycle count is outside of the telemetry data collection operating range associated with the disk read/write cycle range. The telemetry data collection management computing module 210 can determine a weighted value for the runtime characteristics of the disk read/write cycle count of the information handling system 202.

For example, the telemetry data collection management computing module 210 can determine if the system management interrupt (SMI) duration is outside of a threshold range. In some examples, the telemetry data collection management computing module 210 can identify the runtime characteristics of the computing components 212 by identifying the SMI duration of the information handling system 202. The telemetry data collection management computing module 210 can compare the particular runtime characteristic to the telemetry data collection operating range associated with the particular runtime characteristics by comparing the SMI duration of the information handling system 202 to the telemetry data collection operating range associated with a SMI duration range of the information handling system 202. The telemetry data collection management computing module 210 determines whether the particular runtime characteristic is outside of the telemetry data collection operating range by determining that the SMI duration count is outside of the telemetry data collection operating range associated with the SMI duration range. The telemetry data collection management computing module 210 can determine a weighted value for the runtime characteristic of the SMI duration of the information handling system 202.

For example, the telemetry data collection management computing module 210 can determine if the usage of the battery (battery drain) is outside of a threshold range. In some examples, the telemetry data collection management computing module 210 can identify the runtime characteristics of the computing components 212 by identifying the battery drain (battery usage) of the information handling system 202. The telemetry data collection management computing module 210 can compare the particular runtime characteristic to the telemetry data collection operating range associated with the particular runtime characteristics by comparing the battery drain (battery usage) of the information handling system 202 to the telemetry data collection operating range associated with a battery drain (battery usage) range of the information handling system 202. The telemetry data collection management computing module 210 determines whether the particular runtime characteristic is outside of the telemetry data collection operating range by determining that the battery drain (battery usage) is outside of the telemetry data collection operating range associated with the battery drain (battery usage). The telemetry data collection management computing module 210 can determine a weighted value for the runtime characteristic of the battery usage/battery drain of the information handling system 202.

For example, the telemetry data collection management computing module 210 can determine if the rate of data collection (by one or more computing components 212) is decreasing below a threshold range. In some examples, the telemetry data collection management computing module 210 can identify the runtime characteristics of the computing components 212 by identifying the rate of data collection (by one or more computing components 212) of the information handling system 202. The telemetry data collection management computing module 210 can compare the particular runtime characteristic to the telemetry data collection operating range associated with the particular runtime characteristics by comparing the rate of data collection (by one or more computing components 212) of the information handling system 202 to the telemetry data collection operating range associated with the rate of data collection (by one or more computing components 212) of the information handling system 202. The telemetry data collection management computing module 210 determines whether the particular runtime characteristic is outside of the telemetry data collection operating range by determining that the rate of data collection (by one or more computing components 212) is decreasing below a threshold telemetry data collection operating range associated with the data collection (by one or more computing components 212). The telemetry data collection management computing module 210 can determine a weighted value for the runtime characteristic of the rate of data collection of the information handling system 202.

For example, the telemetry data collection management computing module 210 can determine if the processor utilization is outside of a threshold range. In some examples, the telemetry data collection management computing module 210 can identify the runtime characteristics of the computing components 212 by identifying the processor utilization of the information handling system 202. The telemetry data collection management computing module 210 can compare the particular runtime characteristic to the telemetry data collection operating range associated with the particular runtime characteristics by comparing the processor utilization of the information handling system 202 to the telemetry data collection operating range associated with a processor utilization range of the information handling system 202. The telemetry data collection management computing module 210 determines whether the particular runtime characteristic is outside of the telemetry data collection operating range by determining that the processor utilization is outside of the telemetry data collection operating range associated with the processor utilization. The telemetry data collection management computing module 210 can determine a weighted value for the runtime characteristic of the processor utilization of the information handling system 202.

For example, the telemetry data collection management computing module 210 can determine if the memory utilization is outside of a threshold range. In some examples, the telemetry data collection management computing module 210 can identify the runtime characteristics of the computing components 212 by identifying the memory utilization of the information handling system 202. The telemetry data collection management computing module 210 can compare the particular runtime characteristic to the telemetry data collection operating range associated with the particular runtime characteristic by comparing the memory utilization of the information handling system 202 to the telemetry data collection operating range associated with a memory utilization range of the information handling system 202. The telemetry data collection management computing module 210 determines whether the particular runtime characteristic is outside of the telemetry data collection operating range by determining that the memory utilization is outside of the telemetry data collection operating range associated with the memory utilization. The telemetry data collection management computing module 210 can determine a weighted value for the runtime characteristic of the memory utilization of the information handling system 202.

For example, the telemetry data collection management computing module 210 can determine if the network utilization is outside of a threshold range. In some examples, the telemetry data collection management computing module 210 can identify the runtime characteristics of the computing components 212 by identifying the network utilization of the information handling system 202. The telemetry data collection management computing module 210 can compare the particular runtime characteristic to the telemetry data collection operating range associated with the particular runtime characteristic by comparing the network utilization of the information handling system 202 to the telemetry data collection operating range associated with a network utilization range of the information handling system 202. The telemetry data collection management computing module 210 determines whether the particular runtime characteristic is outside of the telemetry data collection operating range by determining that the network utilization is outside of the telemetry data collection operating range associated with the network utilization. The telemetry data collection management computing module 210 can determine a weighted value for the runtime characteristic of the network utilization of the information handling system 202.

The telemetry data collection management computing module 210 determines if there is a further runtime characteristic to identify, at 314. If the telemetry data collection management computing module 210 determines that there is a further runtime characteristic to identify, the process returns to step 306.

The telemetry data collection management computing module 210 determines, based on the comparing, whether the particular runtime characteristic is outside of the telemetry data collection range associated with the particular runtime characteristic, at 310. In some examples, if the telemetry data collection management computing module 210 determines that the particular runtime characteristic is not outside of the telemetry data collection range associated with the particular runtime characteristics, the telemetry data collection management computing module 210 proceeds to step 314.

Concurrently with step 306, the telemetry data collection management computing module 210, after determining that the operating conditions of the computing components 212 indicate the telemetry collection mode of the computing components 212, in response, performs telemetry data collection of the computing components 212, including the telemetry data collection management computing module 210 identifying a particular historical characteristic of the computing components 212, at 316. In some examples, data indicating the historical characteristics of the computing components 212 can be stored at the storage device 213. The telemetry data collection management computing module 210 compares the particular historical characteristic with a telemetry data collection operating range associated with the particular historical characteristic, at 318. For example, the telemetry data collection management computing module 210 can access the telemetry data collection policy 230. The telemetry data collection policy 230 can associate, for each historical characteristic, the telemetry data collection operating range for the historical runtime characteristic. The telemetry data collection management computing module 210 determines, based on the comparing, whether the particular historical characteristic is outside of the telemetry data collection range associated with the particular historical characteristic, at 320. In some examples, if the telemetry data collection management computing module 210 determines that the particular historical characteristic is outside of the telemetry data collection range associated with the particular historical characteristic, the telemetry data collection management computing module 210 determines a weighted value of the particular historical characteristic, at 322.

For example, the telemetry data collection management computing module 210 can determine if the information handling system 202 has experienced over a threshold number of system failures (blue screen of deaths—BSOD). In some examples, the telemetry data collection management computing module 210 can identify the historical characteristics of the computing components 212 by identifying a number of system failures of the information handling system 202. The telemetry data collection management computing module 210 can compare the particular historical characteristic to the telemetry data collection operating range associated with the particular historical characteristic by comparing the number of system failures of the information handling system 202 to the telemetry data collection operating range associated with a system failure range of the information handling system 202. The telemetry data collection management computing module 210 determines whether the particular historical characteristic is outside of the telemetry data collection operating range by determining that the number of system failures is outside of the telemetry data collection operating range associated with system failure range. The telemetry data collection management computing module 210 can determine a weighted value for the historical characteristic of the number of system failures of the information handling system 202.

For example, the telemetry data collection management computing module 210 can determine if the information handling system 202 has experienced over a threshold number of thermal events (trips, power shutdown). In some examples, the telemetry data collection management computing module 210 can identify the historical characteristics of the computing components 212 by identifying a number of thermal events of the information handling system 202. The telemetry data collection management computing module 210 can compare the particular historical characteristic to the telemetry data collection operating range associated with the particular historical characteristic by comparing the number of thermal events of the information handling system 202 to the telemetry data collection operating range associated with a thermal events range of the information handling system 202. The telemetry data collection management computing module 210 determines whether the particular historical characteristic is outside of the telemetry data collection operating range by determining that the number of thermal events is outside of the telemetry data collection operating range associated with the thermal events range. The telemetry data collection management computing module 210 can determine a weighted value for the historical characteristic of the number of thermal events of the information handling system 202.

For example, the telemetry data collection management computing module 210 can determine if the information handling system 202 has experienced acoustic noise above a threshold (the acoustic noise including fan noise, PSU fan noise, power adaptor noise, and the like). In some examples, the telemetry data collection management computing module 210 can identify the historical characteristics of the computing components 212 by identifying a number of times the information handling system 202 has been associated with acoustic noise. The telemetry data collection management computing module 210 can compare the particular historical characteristic to the telemetry data collection operating range associated with the particular historical characteristic by comparing the number of times the information handling system 202 has been associated with acoustic noise to the telemetry data collection operating range associated with an acoustic noise threshold of the information handling system 202. The telemetry data collection management computing module 210 determines whether the particular historical characteristic is outside of the telemetry data collection operating range by determining the number of times the information handling system 202 has been associated with acoustic noise greater than the telemetry data collection operating threshold associated with acoustic noise. The telemetry data collection management computing module 210 can determine a weighted value for the historical characteristic of the number of acoustic noise events of the information handling system 202.

For example, the telemetry data collection management computing module 210 can determine if the information handling system 202 has experienced over a threshold number of fall/shock events. In some examples, the telemetry data collection management computing module 210 can identify the historical characteristics of the computing components 212 by identifying a number of fall/shock events of the information handling system 202. The telemetry data collection management computing module 210 can compare the particular historical characteristic to the telemetry data collection operating range associated with the particular historical characteristic by comparing the number of fall/shock events of the information handling system 202 to the telemetry data collection operating range associated with a fall/shock events threshold range of the information handling system 202. The telemetry data collection management computing module 210 determines whether the particular historical characteristic is outside of the telemetry data collection operating range by determining that the number of fall/shock events is outside of the telemetry data collection operating range associated with fall/shock events threshold range. The telemetry data collection management computing module 210 can determine a weighted value for the historical characteristic of the number of fall/shock events of the information handling system 202.

The telemetry data collection management computing module 210 determines if there is a further historical characteristic to identify, at 324. If the telemetry data collection management computing module 210 determines that there is a further historical characteristic to identify, the process returns to step 316.

The telemetry data collection management computing module 210 determines, based on the comparing, whether the particular historical characteristic is outside of the telemetry data collection range associated with the particular historical characteristic, at 320. In some examples, if the telemetry data collection management computing module 210 determines that the particular historical characteristic is not outside of the telemetry data collection range associated with the particular historical characteristic, the telemetry data collection management computing module 210 proceeds to step 324.

If the telemetry data collection management computing module 210 determines that there are no further runtime characteristics and no further historical characteristics (at 314 and 324, respectively), the method proceeds to step 326. At step 326, the telemetry data collection management computing module 210 determines a summation of i) the values of the runtime characteristics that are outside of respective telemetry data collection operating ranges and ii) the values of the historical characteristics that are outside of the respective telemetry data collection operating ranges. That is, in some examples, the telemetry data collection management computing module 210 determines a summation of i) the weighted values of the runtime characteristics that are outside of respective telemetry data collection operating ranges and ii) the weighted values of the historical characteristics that are outside of the respective telemetry data collection operating ranges.

The telemetry data collection management computing module 210 compares the aggregated value of i) the values of the runtime characteristics that are outside of respective telemetry data collection operating ranges and ii) the values of the historical characteristics that are outside of the respective telemetry data collection operating ranges, at 328. In some examples, the telemetry data collection management computing module 210 determines, based on the comparing, whether the aggregated value is greater than a threshold, at 330. Specifically, the telemetry data collection management computing module 210 utilizes a model 232 to determine whether the aggregated value is greater than a threshold. That is, the threshold can be based and/or indicated by the model 232. The model 232 can be previously generated, and can be based on previous testing of the information handling system 202 and the computing components 212.

In some examples, the telemetry data collection management computing module 210 determines that the aggregated value is greater than the threshold (at 330), and in response, adjusts a frequency of the telemetry data collection of the computing components 212 for a period of time, at 332. That is, the telemetry data collection management computing module 210 determines that the summation of the weighted values of each of the runtime characteristics and the historical characteristics is greater than the threshold (at 330), and in response, adjusts a frequency of the telemetry data collection of the computing components 212 for a period of time. That is, the data collection management computing module 210 adjusts the frequency of telemetry data collection of the computing components 212 for a time period based on the aggregation value of i) the (weighted) values of the runtime characteristics that are outside of respective telemetry data collection operating ranges and ii) the (weighted) values of the historical characteristics that are outside of the respective telemetry data collection operating ranges. In some examples, the telemetry data collection management computing module 210 adjusts the frequency of the telemetry data collection of the computing components 212 for the period of time based on the model 232. That is, the model 232 can indicate for aggregation values a corresponding frequency adjustment value of the telemetry data collection of the computing components 212. That is, for a particular aggregation value, the model 232 can indicate a corresponding frequency adjustment value of the telemetry data collection of the computing components 212.

In some examples, the telemetry data collection management computing module 210 adjusts the frequency of telemetry data collection of the computing components 212 for the time period by throttling the frequency of telemetry data collection of the computing components 212 for the time period. In some examples, the telemetry data collection management computing module 210 adjusts the frequency of telemetry data collection of the computing components 212 for the time period by increasing the frequency of telemetry data collection of the computing components 212 for the time period. In some examples, the telemetry data collection management computing module 210 adjusts the frequency of telemetry data collection of the computing components 212 for the time period by decreasing the frequency of telemetry data collection of the computing components 212 for the time period. In some examples, the telemetry data collection management computing module 210 adjusts the frequency of telemetry data collection of the computing components 212 for the time period by suspending/delaying (temporarily) the frequency of telemetry data collection of the computing components 212 for the time period. In some examples, the telemetry data collection management computing module 210 adjusts the frequency of telemetry data collection of the computing components 212 for the time period by halting (temporarily) the frequency of telemetry data collection of the computing components 212 for the time period.

The telemetry data collection management computing module 210 performs the telemetry data collection of the computing components 212 utilizing the adjusted frequency of telemetry data collection, at 334. The telemetry data collection management computing module 210 can store the collected telemetry data 234 of the computing components 212 at the storage device 214.

The telemetry data collection management computing module 210 can adjust, based on the adjusted frequency of telemetry data collection, a computational parameter of one of the computing components 212, at 336. For example, based on the adjusted frequency of telemetry data collection, the telemetry data collection management computing module 210 can adjust the performance parameters of the processor—increase or decrease the computational cycles of the processor. For example, based on the adjusted frequency of telemetry data collection, the telemetry data collection management computing module 210 can adjust the performance parameters of the information handling system 202—execute only essential software in the background. For example, based on the adjusted frequency of telemetry data collection, the telemetry data collection management computing module 210 can adjust the performance parameters of the information handling system 202—cease updating of software at the information handling system 202. For example, based on the adjusted frequency of telemetry data collection, the telemetry data collection management computing module 210 can adjust the performance parameters of the memory—increase or decrease the read/write cycles at the memory. For example, based on the adjusted frequency of telemetry data collection, the telemetry data collection management computing module 210 can adjust the performance parameters of the GPU—increase or decrease the computational cycles of the GPU. For example, based on the adjusted frequency of telemetry data collection, the telemetry data collection management computing module 210 can adjust the performance parameters of the processor—increase or decrease power draw from a battery and/or AC adapter.

In some examples, the telemetry data collection management computing module 210 determines that the aggregated value is not greater than the threshold (at 330), and in response, maintains a frequency of the telemetry data collection of the computing components 212, at 338. That is, the telemetry data collection management computing module 210 determines that the summation of the weighted values of each of the runtime characteristics and the historical characteristics is not greater than the threshold (at 330), and in response, maintains the frequency of the telemetry data collection of the computing components 212 for a period of time. The method then continues to step 334. For example, based on the maintained frequency of telemetry data collection, the telemetry data collection management computing module 210 can maintain the performance parameters of the processor—maintain the computational cycles of the processor. For example, based on the maintained frequency of telemetry data collection, the telemetry data collection management computing module 210 can maintain the performance parameters of the information handling system 202—execute all software appropriately. For example, based on the maintained frequency of telemetry data collection, the telemetry data collection management computing module 210 can maintain the performance parameters of the information handling system 202—updating of software at the information handling system 202 as appropriate. For example, based on the maintained frequency of telemetry data collection, the telemetry data collection management computing module 210 can maintain the performance parameters of the memory—maintain the read/write cycles at the memory. For example, based on the maintained frequency of telemetry data collection, the telemetry data collection management computing module 210 can maintain the performance parameters of the GPU—maintain the computational cycles of the GPU. For example, based on the maintained frequency of telemetry data collection, the telemetry data collection management computing module 210 can maintain the performance parameters of the processor—maintain power draw from a battery and/or AC adapter.

In some examples, the telemetry data collection management computing module 210 can determine that the operating conditions of the computing components 212 do not indicate a telemetry collection mode of the computing components 212, at 304. In other words, the telemetry data collection management computing module 210 determines that the computing components 212 are not in a condition for further telemetry data collection thereof. The method then proceeds back to step 302.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing telemetry data collection of computing components of an information handling system, the method comprising:
identifying operating conditions of the computing components of the information handling system;
determining that the operating conditions of the computing components indicate a telemetry collection mode of the computing components, and in response, performing telemetry data collection of the computing components, including:
identifying runtime characteristics of the computing components of the information handling system;
for each of the runtime characteristics:
comparing the particular runtime characteristic to a telemetry data collection operating range associated with the particular runtime characteristic;
determining, based on the comparing, whether the particular runtime characteristic is outside of the telemetry data collection operating range associated with the particular runtime characteristic;
determining an aggregation value of the runtime characteristics that are outside of respective telemetry data collection operating ranges; and
adjusting a frequency of the telemetry data collection of the computing components for a period of time based on the aggregation value of the runtime characteristics that are outside of respective telemetry data collection operating ranges.

2. The computer-implemented method of claim 1, wherein the computing components include one or more of a central processing unit (CPU), memory, disk drive, a graphics processing unit (GPU), fan, thermistors, and battery.

3. The computer-implemented method of claim 1,
wherein identifying operating conditions of the computing components further includes identifying a power input state of the information handling system, and
wherein determining that the operating conditions of the computing components indicate the telemetry collection mode further includes determining that the power input state of the information handling system indicates AC power input state, and in response, performing the telemetry data collection of the computing components.

4. The computer-implemented method of claim 1,
wherein identifying operating conditions of the computing components further includes identifying a revolutions per minute (RPM) of a fan over a time period of the information handling system, and
wherein determining that the operating conditions of the computing components indicate the telemetry collection mode further includes determining that the RPM of the fan over the time period of the information handling system is maintained above a threshold, and in response, performing the telemetry data collection of the computing components.

5. The computer-implemented method of claim 1,
wherein identifying the runtime characteristics of the computing components further includes identifying an input power state of the information handling system,
wherein comparing the particular runtime characteristics to the telemetry data collection operating range associated with the particular runtime characteristic further includes comparing the input power state of the information handling system to the telemetry data collection operating range associated with an AC input power state of the information handling system, and
wherein determining whether the particular runtime characteristic is outside of the telemetry data collection operating range further includes determining that the input power state is a DC input power state and outside of the telemetry data collection operating range associated with an AC input power state of the information handling system.

6. The computer-implemented method of claim 1,
wherein identifying the runtime characteristics of the computing components further includes a status of software at the information handling system,
wherein comparing the particular runtime characteristics to the telemetry data collection operating range associated with the particular runtime characteristic further includes comparing update status of the software of the information handling system to the telemetry data collection operating range associated with updating of the software at the information handling system, and
wherein determining whether the particular runtime characteristic is outside of the telemetry data collection operating range further includes determining that the update status of the software indicates a current update of the software is occurring and outside of the telemetry data collection operating range associated with no current updating of the software is occurring.

7. The computer-implemented method of claim 1,
wherein identifying the runtime characteristics of the computing components further includes identifying a disk read/write cycle of the information handling system,
wherein comparing the particular runtime characteristics to the telemetry data collection operating range associated with the particular runtime characteristic further includes comparing the disk read/write cycle of the information handling system to the telemetry data collection operating range associated with a disk read/write cycle range of the information handling system, and
wherein determining whether the particular runtime characteristic is outside of the telemetry data collection operating range further includes determining that the disk read/write cycle is outside of the disk read/write cycle range.

8. The computer-implemented method of claim 1,
wherein identifying the runtime characteristics of the computing components further includes identifying a system management interrupt (SMI) duration of the information handling system,
wherein comparing the particular runtime characteristics to the telemetry data collection operating range associated with the particular runtime characteristic further includes comparing the SMI duration of the information handling system to the telemetry data collection operating range associated with a SMI duration range of the information handling system, and
wherein determining whether the particular runtime characteristic is outside of the telemetry data collection operating range further includes determining that the SMI duration is outside of the SMI duration range.

9. The computer-implemented method of claim 1, further including:
identifying historical characteristics of the information handling system;
for each of the historical characteristics:
comparing the particular historical characteristic to a telemetry data collection operating range associated with the particular historical characteristic;
determining, based on the comparing, whether the particular historical characteristic is outside of the telemetry data collection operating range associated with the historical runtime characteristic;
determining the aggregation value of i) the runtime characteristics that are outside of respective telemetry data collection operating ranges and ii) the historical characteristics that are outside of respective telemetry data collection operating ranges; and
adjusting the frequency of the telemetry data collection of the computing components for the period of time based on the aggregation value of i) the runtime characteristics that are outside of respective telemetry data collection operating ranges and ii) the historical characteristics that are outside of respective telemetry data collection operating ranges.

10. The computer-implemented method of claim 9,
wherein identifying the historical characteristics of the computing components further includes identifying a number of system failures of the information handling system,
wherein comparing the particular runtime characteristics to the telemetry data collection operating range associated with the particular runtime characteristic further includes comparing the number of system failures of the information handling system to the telemetry data collection operating range associated with a system failure range of the information handling system, and
wherein determining whether the particular runtime characteristic is outside of the telemetry data collection operating range further includes determining that the number of system failures is outside of the system failure range.

11. The computer-implemented method of claim 1, wherein adjusting the frequency of telemetry data collection of the computing components for the time period includes throttling the frequency of the telemetry data collection of the computing components for the time period.

12. The computer-implemented method of claim 1, wherein adjusting the frequency of telemetry data collection of the computing components for the time period includes suspending the frequency of the telemetry data collection of the computing components for the time period.

13. The computer-implemented method of claim 1,
wherein determining an aggregation value of the runtime characteristics that are outside of respective telemetry data collection operating ranges further includes:
determining, for each runtime characteristic that is outside of respective telemetry data collection operating ranges, a weighted value of the runtime characteristic; and
determining a summation of the weighted values of each of the runtime characteristics,
wherein adjusting the frequency of the telemetry data collection of the computing components further includes:
comparing the summation of the weighted values of each of the runtime characteristics to a threshold;
determining, based on the comparing, that the summation of the weighted values of each of the runtime characteristics is greater than the threshold; and
in response to determining that the summation of the weighted values of each of the runtime characteristics is greater than the threshold, adjusting the frequency of the telemetry data collection of the computing components for the time period.

14. The computer-implemented method of claim 1, further including:
adjusting, based on the adjusted frequency of the telemetry data collection, a computational parameter of a particular computing component.

15. An information handling system comprising a processor having access to memory media storing instructions executable by the processor to perform operations, comprising:
identifying operating conditions of the computing components of the information handling system;
determining that the operating conditions of the computing components indicate a telemetry collection mode of the computing components, and in response, performing telemetry data collection of the computing components, including:
identifying runtime characteristics of the computing components of the information handling system;
for each of the runtime characteristics:
comparing the particular runtime characteristic to a telemetry data collection operating range associated with the particular runtime characteristic;
determining, based on the comparing, whether the particular runtime characteristic is outside of the telemetry data collection operating range associated with the particular runtime characteristic;
determining an aggregation value of the runtime characteristics that are outside of respective telemetry data collection operating ranges; and
adjusting a frequency of the telemetry data collection of the computing components for a period of time based on the aggregation value of the runtime characteristics that are outside of respective telemetry data collection operating ranges.

16. The information handling system of claim 15, wherein the computing components include one or more of a central processing unit (CPU), memory, disk drive, a graphics processing unit (GPU), fan, thermistors, and battery.

17. The information handling system of claim 15,
wherein identifying operating conditions of the computing components further includes identifying a power input state of the information handling system, and
wherein determining that the operating conditions of the computing components indicate the telemetry collection mode further includes determining that the power input state of the information handling system indicates AC power input state, and in response, performing the telemetry data collection of the computing components.

18. The information handling system of claim 15,
wherein identifying operating conditions of the computing components further includes identifying a revolutions per minute (RPM) of a fan over a time period of the information handling system, and
wherein determining that the operating conditions of the computing components indicate the telemetry collection mode further includes determining that the RPM of the fan over the time period of the information handling system is maintained above a threshold, and in response, performing the telemetry data collection of the computing components.

19. The information handling system of claim 15,
wherein identifying the runtime characteristics of the computing components further includes identifying an input power state of the information handling system,
wherein comparing the particular runtime characteristics to the telemetry data collection operating range associated with the particular runtime characteristic further includes comparing the input power state of the information handling system to the telemetry data collection operating range associated with an AC input power state of the information handling system, and
wherein determining whether the particular runtime characteristic is outside of the telemetry data collection operating range further includes determining that the input power state is a DC input power state and outside of the telemetry data collection operating range associated with an AC input power state of the information handling system.

20. A non-transitory computer-readable medium storing software comprising instructions executable by one or more computers which, upon such execution, cause the one or more computers to perform operations comprising:
identifying operating conditions of the computing components of the information handling system;
determining that the operating conditions of the computing components indicate a telemetry collection mode of the computing components, and in response, performing telemetry data collection of the computing components, including:
identifying runtime characteristics of the computing components of the information handling system;
for each of the runtime characteristics:
comparing the particular runtime characteristic to a telemetry data collection operating range associated with the particular runtime characteristic;
determining, based on the comparing, whether the particular runtime characteristic is outside of the telemetry data collection operating range associated with the particular runtime characteristic;
determining an aggregation value of the runtime characteristics that are outside of respective telemetry data collection operating ranges; and
adjusting a frequency of the telemetry data collection of the computing components for a period of time based on the aggregation value of the runtime characteristics that are outside of respective telemetry data collection operating ranges.
